(19) United States
(12) Patent Application Publication
(10) Pub. No.: US 2026/0148287 A1
(43) Pub. Date: May 28, 2026

(54) REMOTE APPAREL FITTING AND GARMENT LAYERING

(71) Applicant: SpreeAI Corporation, Incline Village, NV (US)

(72) Inventors: Bo Kyung Kim, Brooklyn, NY (US); Danel Dominguez Sullivan, San Diego, CA (US); Tiffany Seojin Kwak, Lawrenceville, GA (US); Aayush Bansal, Pittsburgh, PA (US); Minh Phuoc Vo, Alameda, CA (US); John Imah, Los Angeles, CA (US)

(73) Assignee: SpreeAI Corporation, Incline Village, NV (US)

(21) Appl. No.: 18/962,200

(22) Filed: Nov. 27, 2024

(51) Int. Cl. G06Q 30/0601; G06T 17/20; G06V 10/82; G06V 40/10

(52) U.S. Cl. CPC G06Q 30/0643; G06Q 30/0621; G06T 17/20; G06V 10/82; G06V 40/10

(57) ABSTRACT

In one implementation of remote apparel fitting and garment layering, a processing device determines a digital representation of a subject person wearing a first clothing item. The digital representation is generated using a machine-learning model based on an image of a subject person and a selection of the first clothing item via a user interface. The digital representation is presented via a display. The processing device then receives, via a user interface, a selection of a second clothing item to remotely try on in combination with the first clothing item. The processing device uses the machine-learning model to display an updated digital representation of the subject person wearing the first clothing item layered with the second clothing item.

### BACKGROUND

Clothing sizes can vary significantly across different brands, and even within the same brand. This means that a person might wear one size of a particular clothing item from a certain brand and find it fits well, but the same size from another brand might not fit well. Traditionally, shoppers dealt with this issue by trying on clothing items in physical retail locations such as department stores. However, with the increasing trend of online purchasing, people have lost the assurance of confidently selecting clothing items and sizes that fit well. In addition, remote purchasing has also increased the difficulty in picking clothing items that match one another or with another clothing item already owned by the shopper.

### SUMMARY

Techniques and systems for remote apparel fitting and garment layering are described. In one example, a processing device receives an input image that depicts a subject person (e.g., an online consumer), preferably from a front- or side-facing perspective. A selection of a first clothing item is also received. For example, the person is browsing an online catalog of clothing items and trying to find clothing items (e.g., shirts) that fit well. A machine-learning model uses the image to determine measurements of the subject person that correlate to one or more dimensions of the clothing item. In some implementations, the machine-learning model determines the measurements after generating a mesh model of the subject person. The machine-learning model is then used to determine the fit of the first clothing item on the subject person and present a composite image that represents the fit of the clothing item on the subject person overlayed on a reproduced image of the subject person wearing the first clothing item.

The processing device then receives, via the user interface, a selection of a second clothing item to remotely try on in combination with the first clothing item. The second clothing item can be from the same marketplace, a different marketplace, or otherwise uploaded by the user. The processing device uses the machine-learning model to display an updated digital representation of the subject person wearing the first clothing item layered with the second clothing item. In this way, a consumer can quickly and confidently build an outfit or find clothing items, including accessories, that match other clothing items.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described regarding the accompanying figures. Entities represented in the figures indicate one or more entities; thus, reference is made interchangeably to single or plural forms of the entities in the discussion.

FIG. 1 illustrates a digital medium environment in an example implementation that is operable to employ remote apparel fitting and garment layering techniques as described herein.

FIG. 2 depicts a system in an example implementation that shows the operation of a digital fitting service and a garment layering service in greater detail employing the techniques described herein.

FIG. 3 depicts a system in an example implementation showing the operation of an image compositing module of the digital fitting service and garment layering service of FIG. 2 in greater detail.

FIG. 4 depicts a system and procedure in an example implementation for training a machine-learning model.

FIGS. 5A through 5C depict an example user interface to employ remote apparel fitting and garment layering.

FIG. 6 is a flow diagram depicting a procedure in an example implementation of operations performable for accomplishing a result of remote apparel fitting and garment layering.

FIG. 7 illustrates an example system including various components of an example device that can be implemented as any type of computing device as described and/or utilized concerning the previous figures to implement embodiments of the techniques described herein.

### DETAILED DESCRIPTION

### Overview

Ordering clothes online can be both convenient and frustrating. On one hand, it offers unmatched convenience and the ability to browse numerous options. However, this convenience comes with its fair share of frustrations. For instance, one of the biggest challenges is being unable to physically try on the clothes before purchasing. Sizing discrepancies between brands and even different styles within the same brand make it difficult to find the right fit. Similarly, it is difficult to determine how different clothing items will look together or if the size of one will match the sizing of another clothing item. This often leads to the inconvenience of returning or exchanging items, incurring additional costs, and wasting time.

Furthermore, online clothes shopping is challenging because it is difficult to accurately assess color, material quality, and how clothes drape from online photos. The limitations of digital images mean that items can look vastly different in person than they did on the screen. For example, two different clothing items may appear to have a similar fit or color when viewed independently, but once matched up, the clothing items may clash or not fit well together. As a result, it is challenging to predict how clothes will fit and look without being able to try them on, which makes online clothes shopping a daunting and often disappointing experience, especially when trying to buy clothing items to match other items or accessories.

Retailers and manufacturers often provide sizing charts that display a garment's measurements in different sizes. These charts typically include key measurements like chest, waist, hips, inseam, and/or sleeve length, and indicate which size (e.g., small (S), medium (M), large (L), etc.) corresponds to each range of body measurements. Sizing charts are intended to assist consumers, especially online shoppers, choose well-fitting clothes. However, sizing charts can be difficult to navigate because sizing varies across brands and body types. Because they generally focus on a few key measurements, sizing charts do not account for other factors like body shape, height, and personal preferences.

Similarly, retailers and manufacturers often provide preview images of their clothing items, including different images of the different colors or prints available for a given item. However, many online experiences make it difficult to compare clothing items to one another and assess the color and/or fit match. Even if composite or comparison images are available, it is still difficult to determine how multiple clothing items will fit and look together for a particular shopper.

In contrast, the described techniques for remote apparel fitting and garment layering give online shoppers greater confidence in selecting clothing items and sizes that fit well and match their preferences and one another. Together with measurement details of the selected clothing item, a machine-learning model generates an image or three-dimensional representation of multiple clothing items on a digital representation of the shopper. In addition, the described techniques provide an interactive and intuitive user interface to allow shoppers to switch different clothing items at different layers of an ensemble. For example, the user interface allows users to digitally try on a pair of pants and then find a shirt that goes well with the selected pants in color and fit. In this way, users can make online purchases more confidently, find clothes that fit them better, and reduce the need to return purchases.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Remote Fitting With Garment Layering Environment

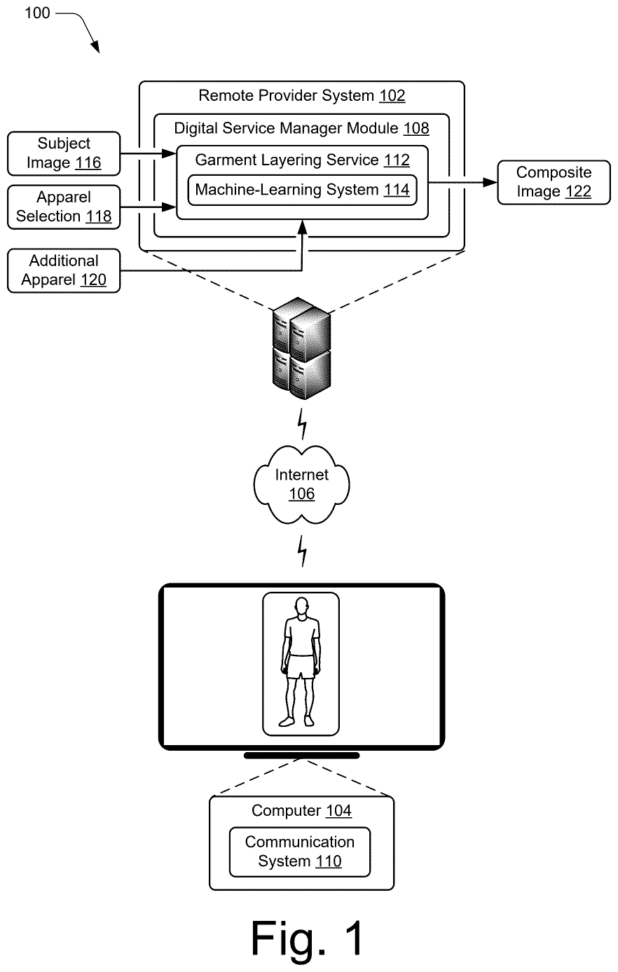

FIG. 1 illustrates a digital medium environment 100 in an example implementation that is operable to employ remote apparel fitting and garment layering techniques as described herein. The illustrated digital medium environment 100 includes a remote provider system 102 and a computer 104 that are communicatively coupled, one to another, via the Internet 106 or another wired or wireless network. Computing systems for the remote provider system 102 and the computer 104 are configurable in various ways. For instance, computer 104 is associated with a user, and remote provider system 102 is a remote computing system (e.g., one or more servers) configured to employ the described techniques and systems for remote apparel fitting and garment layering.

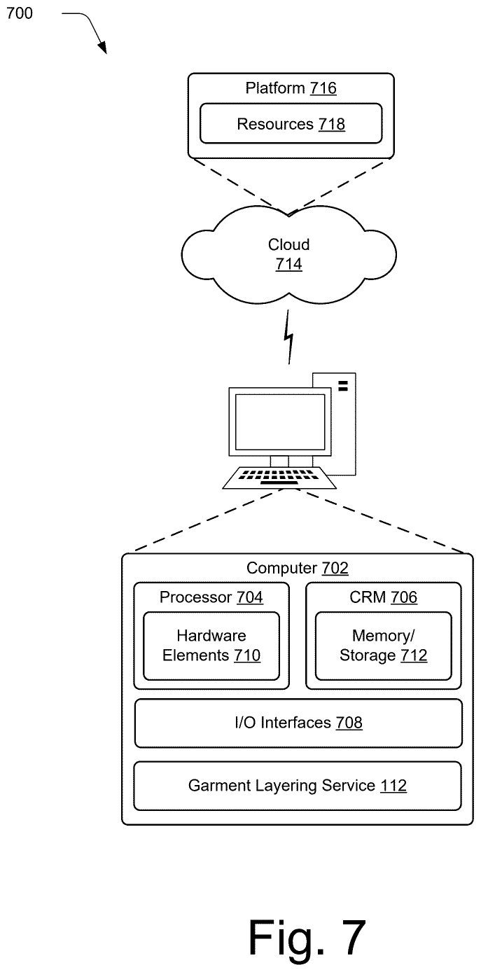

A computing system, for instance, is configurable as a desktop computer, laptop computer, mobile device (e.g., assuming a handheld configuration such as a tablet or mobile phone), server, and so forth. Thus, the remote provider system 102 or the computer 104 can range from a full-resource device with substantial memory and processor resources (e.g., servers and personal computers) to a low-resource device with limited memory and/or processing resources (e.g., some mobile devices). Additionally, although a single computing device is shown for the computer 104 and described in instances in the following discussion, a computing system is also representative of a plurality of different devices, such as multiple servers utilized by a business to perform operations “over the cloud” for the remote provider system 102 and as further described in relation to FIG. 7.

The remote provider system 102 includes a digital service manager module 108 implemented using hardware and software resources (e.g., a processing device and computer-readable storage medium) to support one or more digital services (e.g., an online marketplace). The digital services are made available remotely via the Internet 106 to computing devices (e.g., computer 104).

The digital services are scalable through implementation by the hardware and software resources and support a variety of functionalities, including accessibility, verification, real-time processing, analytics, load balancing, and so forth. Examples of digital services include a social media service, online marketplace, streaming service, digital content repository service, content collaboration service, and so on. Accordingly, in the illustrated example, a communication system 110 (e.g., browser, network-enabled application, and so on) is utilized by the computer 104 to access digital services via the Internet 106. The result of processing using the digital services is then returned to the computer 104 via the Internet 106.

In the illustrated digital medium environment 100, the digital services include a garment layering service 112 for assisting online purchasers in finding clothes and sizes that fit well and combining various clothing items or accessories to complete an ensemble or make more informed purchasing decisions. For example, the garment layering service 112 uses a machine-learning system 114 to process a subject image 116 and apparel selection 118 to generate an initial composite image. Given a subject image 116 capturing an image of the purchaser (or another consumer), the garment layering service 112 (or another service, such as a remote fitting service) generates the initial composite image that includes a digital representation of the purchaser in the selected clothing item and an image of its fit on the purchaser. The garment layering service 112 readily depicts the purchaser with alternate sizes or clothing items, including additional apparel 120, upon the user's interaction with a user interface (UI) of the computer 104. Visually, the garment layering service 112 swaps the original clothing in subject image 116 with different clothing items realistically and plausibly and provides an indication of their fit on the user and how the different clothing items look together.

As previously described, conventional online marketplaces generally just provide a sizing chart with limited measurements to assist users in selecting an appropriate size and/or determining if the clothing item will fit the user as desired. In addition, most conventional online marketplaces do not give a user the ability to mix and match multiple clothing items in a visual representation to give the user greater confidence in selecting multiple clothing items for purchase or selecting a particular clothing item to match an item already owned by the user. In the described remote apparel fitting and garment layering techniques, however, image compositing gives users greater confidence in selecting clothing sizes and items that fit them well and match a desired style.

To do so, the garment layering service 112 is configurable to employ the machine-learning system(s) 114 to determine a user's dimensions (e.g., chest size, shoulder width, etc.) from a single uploaded image (e.g., the subject image 116). The user's dimensions are used to generate a mesh model of the user and the initial composite image of the user wearing the selected clothing item(s). This machine-learning system 114 also uses an indication of additional apparel 120 to generate one or more composite images 122 that display the selected clothing items on the mesh model representation of the user. The composite image 122 provides a digital representation of the user (based on the subject image 116) or a mannequin wearing the selected clothing item with similar body proportions. The composite image 122 also indicates the fit and visual appearance of the clothing items on the digital representation of the user. Further discussion of these and other examples is included in the following section and shown in the corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Fitting and Garment Layering

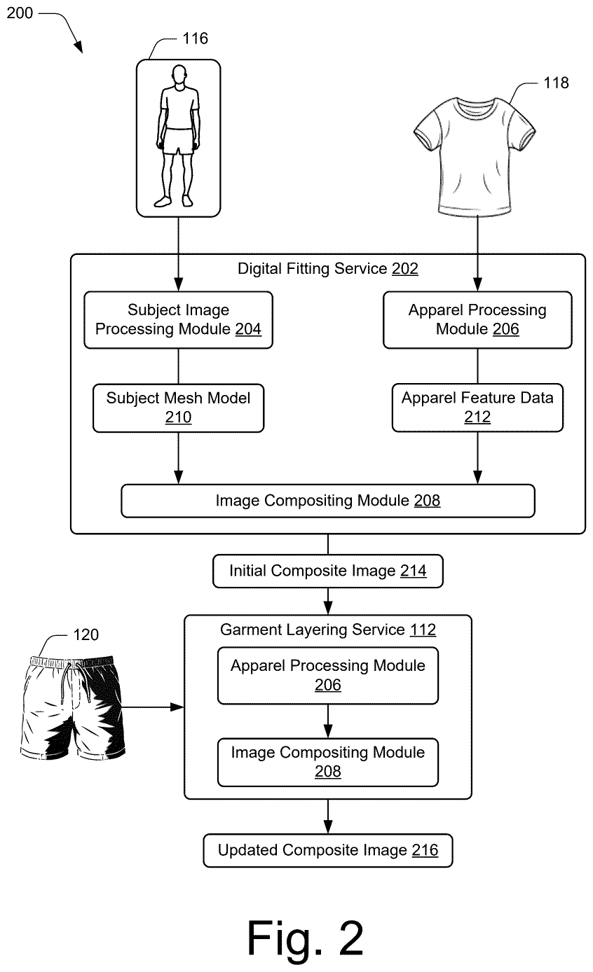

FIG. 2 depicts a system 200 in an example implementation that shows the operation of a digital fitting service 202 and a garment layering service 112 of FIG. 1 in greater detail employing the techniques described herein. The digital fitting service 202 and garment layering service 112 are configurable to implement a pipeline to support the generation of a composite figure that indicates how multiple clothing items fit on a subject. To do so, the digital fitting service 112 employs a subject image processing module 204, an apparel processing module 206, and an image compositing module 208. Similarly, the garment layering service 112 employs the apparel processing module 206 and the image compositing module 208.

The subject image processing module 204 is configured to process the subject image 116 to generate a subject mesh model 210. In particular, the subject image processing module 204 uses a machine-learning model to extract the subject's measurements (e.g., chest width, torso length, etc.) from the subject image 116 and generate the subject mesh model 210. The subject mesh model 210 is proportioned to match the extracted or determined measurements of the subject.

For example, the image processing module 204 uses a skinned multi-person linear (SMPL) model to generate the subject mesh model 210. An SMPL model is a parametric three-dimensional (3D) body model that utilizes machine learning. SPML models use a blend of linear skinning and blend shapes to represent a wide range of human body shapes and poses. Linear skinning uses weights to deform a base mesh according to a skeleton, allowing for basic body movements. Blend shapes are pre-defined shapes added to the base mesh to capture details like muscle bulges. The SMPL model of the image processing module 204 captures various body shapes using a relatively small number of parameters to represent complex body shapes, making it efficient for storage and real-time processing.

The parameters that control the weights and blend shapes in SMPL models are learned from a large dataset of 3D body scans, allowing them to represent a statistically realistic range of human body shapes. Here, the SMPL model is further trained on two-dimensional (2D) images or photographs of individuals to be able to generate body meshes (e.g., the subject mesh model 210) from uploaded images (e.g., the subject image 116), including a single uploaded image. The SMPL model learns the statistical relationships between the pose, shape, and appearance of the human body in the 2D images. The learned parameters are then used to define the weights and blend shapes within the SMPL model.

The subject mesh model 210 is a 3D representation of the human body (e.g., the subject in the subject image 116) made up of polygons (e.g., triangles). The polygons connect to form a surface that defines the shape and volume of the body. The subject mesh model 210 provides a realistic body shape for the subject (e.g., consumer) to allow their measurements to be extracted or determined for digital fitting and garment layering.

Low-poly models use fewer polygons, making them better suited for real-time applications where performance is crucial. High-poly models have a much higher polygon count, resulting in finer details and a more realistic appearance, but they require more processing power to render. Static meshes represent a fixed pose of the human body, while rigged meshes have a skeletal structure embedded within them, allowing for animation and various poses. In some variations, mesh models are textured with images (e.g., skin textures) to add details and realism. The subject image processing module 204 selects between low-poly and high-poly models based on available computing resources in one implementation. The generation of the subject mesh model 210 is described in greater detail in U.S. patent application Ser. No. 18/787,363, which was filed on Jul. 29, 2024 and is hereby incorporated in its entirety herein.

The apparel processing module 206 is configured to analyze the apparel selection 118 and generate or look up apparel feature data 212. The apparel feature data 212 is generally known by the digital fitting service 202 or readily available for lookup by the apparel processing module 206. In one implementation, the apparel processing module 206 looks up at least some of the apparel feature data 212 (e.g., a minimum set of measurements) for the apparel selection 118 and extrapolates or determines other apparel feature data 212 based on the provided data. The apparel feature data 212 includes different measurements (e.g., sleeve length, wrist diameter, neck opening diameter, torso length, inseam, waist circumference) and characteristics (e.g., stretchiness, material, drape, color) of the apparel selection 118.

Outputs of the subject image processing module 204 (e.g., the subject mesh model 210) and the apparel processing module 206 (e.g., apparel feature data 212) are then received as inputs by the image compositing module 208 to generate an initial composite image 214. In particular, the image compositing module 208 is employed to render the subject based on the subject mesh model 210 in relation to the apparel feature data 212 to provide an indication of the apparel's fit on the subject.

The garment layering service 112 is configured to generate an updated composite image 216 that adds or replaces the additional apparel 120 with corresponding items in the initial composite image 214. The garment layering service 112 receives the initial composite image 214 and one or more additional apparel 120 as inputs. The apparel processing module 206 of the garment layering service 112 is configured to analyze the additional apparel 120 and generate or look up corresponding apparel feature data as described above. The apparel processing module 206 also determines layering of the apparel selection 118 and additional apparel 120 to generate a clothing ensemble for the subject mesh model 210.

The image compositing module 208 generates the updated composite image 216. In particular, the image compositing module 208 is employed to render the subject based on the subject mesh model 210 in relation to the apparel feature data 212 to provide garment layering on the subject. Compared with conventional techniques, the garment layering service 112 exhibits improved remote fitting to improve online shopping experiences and reduce the hassle associated with poor fitting and unmatching purchases.

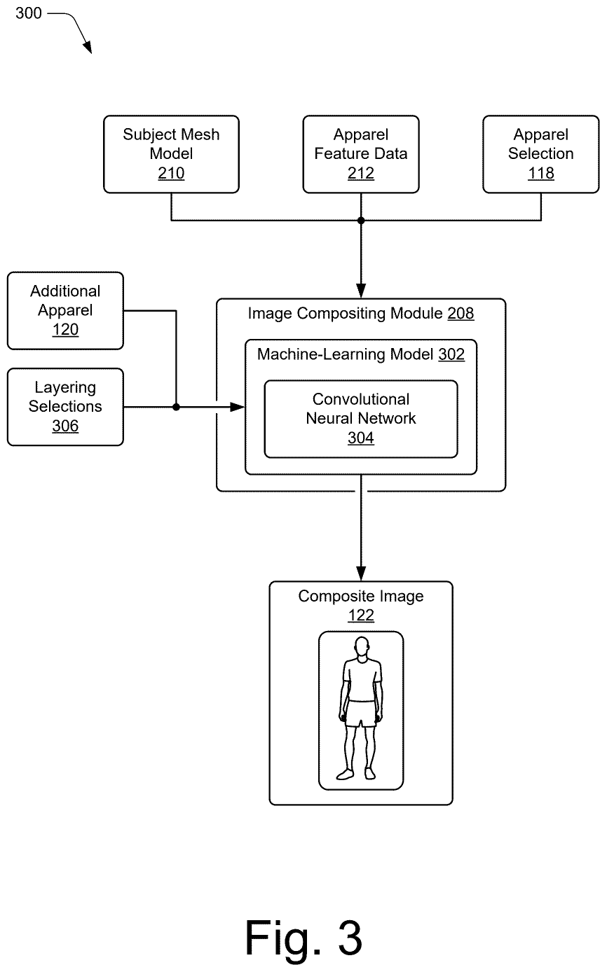

FIG. 3 depicts a system 300 in an example implementation showing an operation of the image compositing module 208 of the digital fitting service 202 and garment layering service 112 of FIG. 2 in greater detail. The image compositing module 208 includes a machine-learning model 302 with a convolutional neural network 304.

The image compositing module 208 receives as inputs the subject mesh model 210, the apparel feature data 212, and an image or digital representation of the apparel selection 118, which are provided to the machine-learning model 302. The image compositing module 208 also receives as inputs apparel feature data 212 for additional apparel 120, an image or digital representation of the additional apparel 120, and layering selections 306. The layering selections 306 can include instructions or user preferences related to the layering of the apparel selection 118 and additional apparel 120. For example, the layering selections 306 include a tuck/untuck preference for a shirt, sock/sockless for shoes, cuffed/not cuffed for pants, number of unbuttoned buttons, or ordering of clothes layers.

The machine-learning model 302 utilizes the convolutional neural network 304 to perform a fitting analysis, garment layering, and image compositing based on generative image models. The convolutional neural network 304 uses the subject mesh model 210 and the apparel feature data 212 to generate garment layering of the apparel selection 118 and/or the additional apparel 120 on the subject. For example, the machine-learning model 302 is trained on example images with different combinations of clothing items and accessories to learn proper layering of garments and default clothing items to display to match the apparel selection 118 and/or the additional apparel 120 (e.g., adding pants to the composite image 122 if the user has not selected bottom clothing).

The convolutional neural network 304 uses the subject mesh model 210, the apparel feature data 212, and the images or digital representations of the apparel selection 118 and additional apparel 120 to generate the composite image 122 that illustrates the subject wearing the selected clothing items. In one implementation, the convolutional neural network 304 is a multi-view convolutional neural network (MVCNN) that uses multiple 2D images of the subject mesh model 210 from different viewpoints as input. The MVCNN is trained on a large dataset of mesh models and their corresponding multi-view images. The trained convolutional neural network 304 generates a new image of the subject mesh model 210 wearing the apparel selection 118 and the additional apparel 120 from a viewpoint that is a preferred view (e.g., front view), even if that view was not included in the training data or the original subject image 116.

In another implementation, the machine-learning model 302 uses a generative adversarial network (GAN) to generate the composite image 122. A generator network takes the subject mesh model 210, the apparel selection 118, and additional apparel 120 as inputs and creates a photorealistic image of the subject wearing the different clothing items. A discriminator network receives both real images of mesh models and the generated images, trying to distinguish between the two. Through an adversarial training process, the generator becomes better at creating images that fool the discriminator, resulting in increasingly realistic outputs. In other implementations, the image compositing module 208 uses rasterization to transform the 3D subject mesh model 208 into a 2D image with the apparel selection 118 and additional apparel 120 or neural radiance fields to generate the composite image 122.

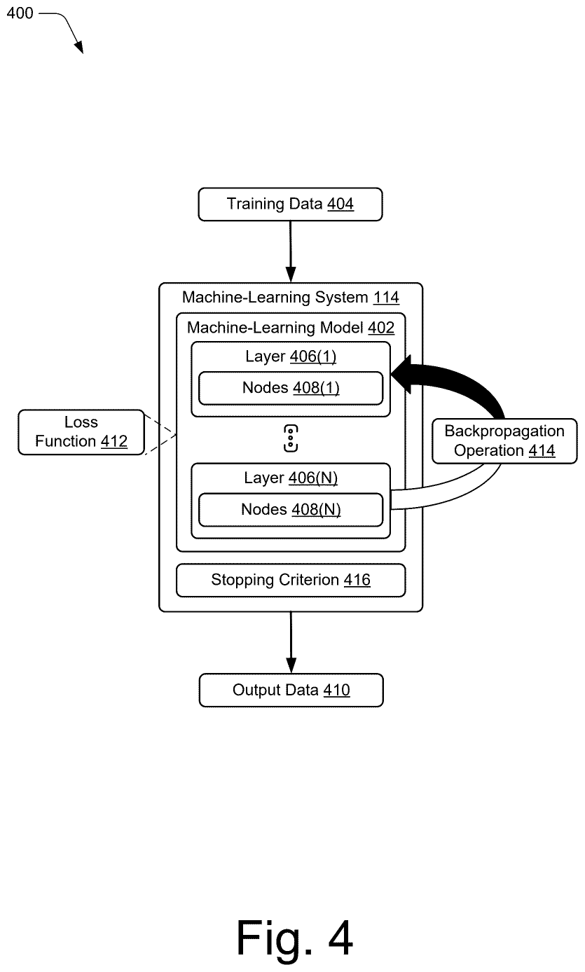

FIG. 4 depicts a system and procedure in an example implementation 400 for training a machine-learning model 402 as part of the machine-learning system 114 of FIG. 1. The machine-learning model 402 is illustrated as implemented as part of the machine-learning system 114. The machine-learning system 114 is representative of functionality to generate training data 404, use the generated training data 404 to train the machine-learning model 402, and/or use the trained machine-learning model 402 as implementing the functionality described herein.

A machine-learning model 402 refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In this context, the machine-learning model 402 employs a diffusion model. A “diffusion model” is a generative machine-learning model for digital content creation (e.g., composite images 122). To train the diffusion model, noise is added to training data samples until the data within the training data samples is obscured. The diffusion model is then trained self-supervised to reverse this process based on training data with a text prompt describing the digital content to be created to generate data samples as the digital content corresponding to the text prompt. To train the diffusion model, the underlying machine-learning model 402 is provided with training data 404 that includes examples of images to train and retrain the model to predict the image to be generated.

In one implementation, the machine-learning model 402 also employs a parametric model. A parametric model uses a fixed number of parameters to represent the data (e.g., mesh models) it describes. In other words, these parameters are essentially the knobs turned to adjust the model's fit to the data. Parametric models use a finite or predetermined set of parameters. Because they have a fixed number of parameters, parametric models are often simpler to train and require less data than non-parametric models.

In the illustrated example, the machine-learning model 402 is configured using a plurality of layers 406(1), . . . , 406(N) having, respectively, a plurality of nodes 408(1), . . . , 408(N). The plurality of layers 406(1)-406(N) are configurable to include an input layer, an output layer, and one or more hidden layers. Calculations are performed by the nodes 408(1)-408(N) within the layers via hidden states through a system of weighted connections that are “learned” during training to implement a variety of tasks (e.g., caption generation).

To train the machine-learning model 402, training data 404 is received that provides examples of “what is to be learned” by the machine-learning model 402, i.e., as a basis to learn patterns from the data. The machine-learning model 402, for instance, collects and preprocesses the training data 404 that includes input features and corresponding target labels, i.e., of what is exhibited by the input features. The machine-learning system 114 then initializes the parameters of the machine-learning model 402, which the machine-learning system 114 uses as internal variables to represent and process information during training and represent interferences gained through training. In an implementation, the training data 404 is separated into batches to improve the processing and optimization efficiency of the parameters during training.

The training data 404 is then received as input and used to generate predictions based on the current state of parameters of layers 406(1)-406(N) and corresponding nodes 408(1)-408(N) of the model. The machine-learning model 402 outputs its result as output data 410. Output data 410 describes an outcome of the task (e.g., generating a composite image).

Training the machine-learning model 402 includes calculating a loss function 412 to quantify a loss associated with operations performed by nodes 408 of the machine-learning model 402. For instance, calculating the loss function 412 includes comparing a difference between predictions specified in the output data 410 with target labels specified by the training data 404. The loss function 412 is configurable in various ways, including regression, the quadratic loss function as part of a least squares technique, and so forth.

Calculating the loss function 412 also includes using a backpropagation operation 414 to minimize the loss function 412, thereby training the parameters of the machine-learning model 402. Minimizing the loss function 412 includes adjusting the weights of the nodes 408(1)-408(N) to minimize the loss and thereby optimize the performance of the machine-learning model 402 for a particular task. The adjustment is determined by computing a gradient of the loss function 412, which indicates a direction to be used to adjust the parameters for minimizing the loss. The parameters of the machine-learning model 402 are then updated based on the computed gradient.

This process continues over several iterations until a stopping criterion 416 is met. The stopping criterion 416 is employed by the machine-learning system 114 in this example to reduce overfitting of the machine-learning model 402, reduce computational resource consumption, and promote an ability to address previously unseen data, i.e., that is not included specifically as an example in the training data 404. Examples of a stopping criterion 416 include but are not limited to a predefined number of epochs, validation loss stabilization, achievement of a performance improvement threshold, or based on performance metrics such as precision and recall.

### Example Remote Fitting Procedures

The following discussion describes techniques for remote apparel fitting and garment layering that are implementable utilizing the described systems and devices. Aspects of each procedure are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are stored on a computer-readable storage medium that causes the hardware to perform the algorithm, e.g., responsive to the execution of the instructions. In portions of the following discussion, reference will be made to FIGS. 1-4.

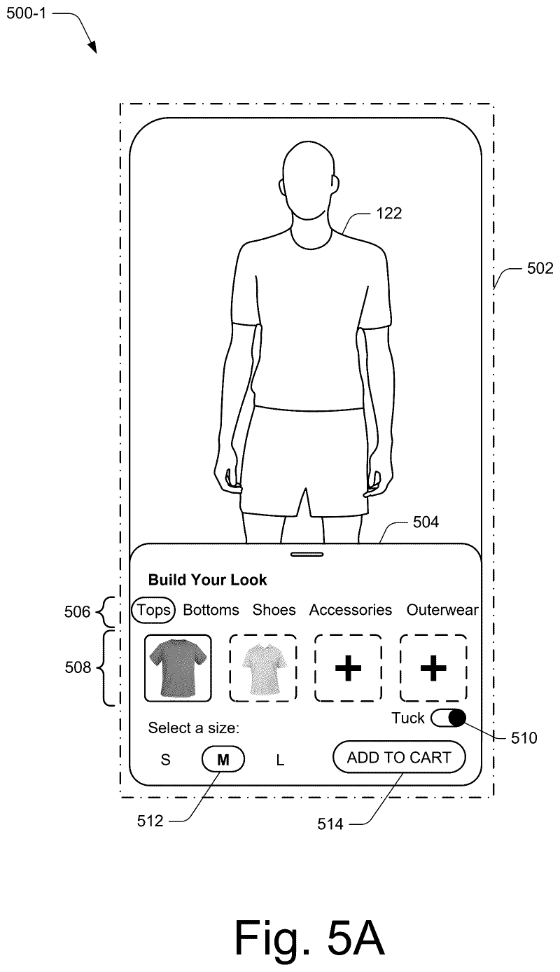

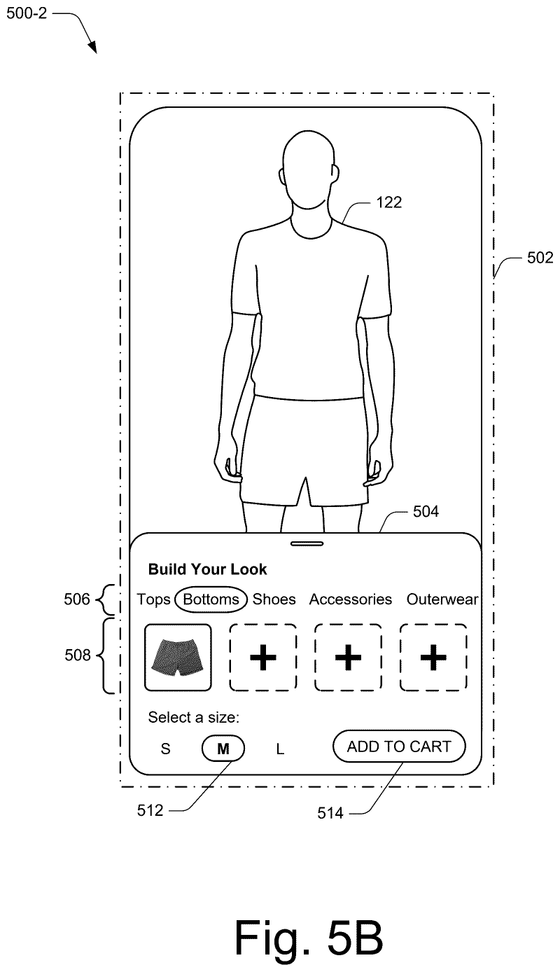

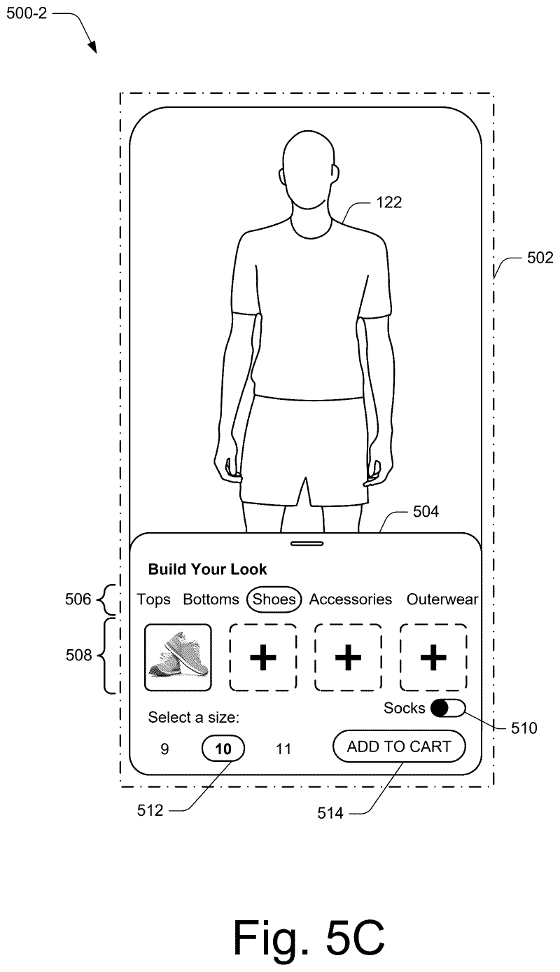

FIGS. 5A through 5C depict an example user interface 502 to employ remote apparel fitting and garment layering. The user interface 502 includes a composite image 122 of the user wearing one or more previously selected clothing items (e.g., the apparel selection 118) and an informational element 504. In other implementations, the user interface 502 includes additional or fewer components.

The composite image 122 represents the subject (e.g., online purchaser) wearing the apparel selection 118. The subject representation can include a mannequin image with body proportions based on the subject mesh model 210. In other implementations, the subject representation reproduces the user based on the subject image 116. The illustrated implementations 500 provide a front-facing view of the composite image 122, but different-facing views are provided in different implementations. In other implementations, the composite image 122 can be rotated or seen from different perspectives.

The informational element 504 includes a “Build Your Look” feature with the option for the user to add additional apparel 120 to the composite image 122 to assist with the purchasing decision for the apparel selection 118 or find additional clothing items for purchase. The informational element 504 includes a category selection 506, a clothing item selection 508, a layering option 510, a size selection 512, and an “Add to Cart” button 514. The category selection 506 includes garment categories for the user to build an outfit for remote fitting. For example, the category selection 506 includes tops, bottoms, shoes, accessories, and outerwear. In other implementations, additional or fewer categories are included in the category selection 506.

The clothing item selection 508 allows the user to select up to four clothing items within the category selection 506 to update the composite image 122. In one example, the clothing item selections 508 are prepopulated by suggested items generated by the garment layering service 112 or another component of the digital fitting service 202. In another example, the clothing item selections 508 are selected by the user from an online catalog associated with the digital fitting service 202 or a personal catalog of uploaded or saved clothing items associated with the user. In yet another example, the clothing item selections 508 are a combination of the previous implementations based on user input upon the user selecting an “+” associated with an empty user interface element. The layering option 510 is selectively shown based on the category selection 506. For example, the layering option 510 is an option for the user to select a top to be shown tucked in or untucked in the composite image 122. Additional examples of the layering option 510 are described with reference to FIGS. 5A through 5C.

The size selection 512 includes an option for the user to select a different size of the additional apparel 120 (with the current selection highlighted or visually indicated). The “Add to Cart” button 514 is another user-interface (UI) element for the user to add the additional apparel 120 to a shopping cart. In other implementations, the informational element 504 includes additional or fewer UI elements, including, for example, an instant purchase button, a preview of similar clothing items with a better fit, or an option to change the color or pattern of the additional apparel 120.

In example 500-1 of FIG. 5A, the user has selected tops as the category selection 506 for the “Build Your Look” feature to layer with the previously selected clothing item(s), which is illustrated by the UI button or outlining around the word “Tops.” In other implementations of the user interface 502, the user's selection is indicated using other visual means. The composite image 122 provides a fitting preview of the user wearing a pair of shorts with a first tee shirt, which is chosen, for example, from the subject image 116 or as a default top to accompany the apparel selection 118 (e.g., the shorts).

The clothing item selections 508 currently include a gray tee shirt and a green polo shirt. In this scenario, the current clothing item selections 508 were prepopulated by the garment layering service 112 to accompany the apparel selection 118. The prepopulated clothing items can be determined based on recent purchasing or viewing trends of the user and/or other users, an ensemble-building recommendation service, or marketplace recommendations. In other implementations, the garment layering service 112 can use other inputs and information sources to prepopulate clothing items for the clothing item selection 508. The informational element 504 also includes two empty spaces with “+” signs allowing users to select additional clothing items from the current marketplace's catalog, saved selections, or other online clothing catalogs.

In the current scenario, the user has selected the gray tee shirt (e.g., as indicated by the solid outline around the shirt). Upon selection of the gray tee shirt, the user is presented with the layering option 510 to tuck or untuck the shirt. In the illustrated example 500-1, the user has opted to shown the selected tee shirt as tucked in for the composite image 122. The user has also selected a medium size (e.g., “M”) for the selected shirt. As the user selects a particular clothing item selection 508 (e.g., the gray tee shirt), the garment layering service 112 automatically updates the composite image 122 with the gray tee shirt so that the user can see how the selected shirt matches the previously selected shorts. In other implementations, the user is presented with a refresh button (or similar UI element) to cause the composite image 122 to be updated based on the current selections. If the user decides that they prefer the tee shirt untucked, the composite image 122 is updated in response to the user unselecting the layering option 510 in the user interface 502.

In example 500-2 of FIG. 5B, the user has selected bottoms as the category selection 506 for the “Build Your Look” feature, which is illustrated by the UI button or outlining around the word “Bottoms.” In other implementations of the user interface 502, the user's selection is indicated using other visual means. The composite image 122 provides a fitting preview of the user wearing the pair of shorts originally selected as the apparel selection 118 (e.g., the shorts).

The clothing item selections 508 currently include the apparel selection 118. In this scenario, the current clothing item selections 508 is prepopulated by the garment layering service 112 with the apparel selection 118. The user has the opportunity to select different bottoms to build a new look or in response to not liking the fit or look of the original apparel selection 118. In another implementation, the garment layering service 112 prepopulates clothing items based on recent purchasing or viewing trends of the user and/or other users, an ensemble-building recommendation service (e.g., based on the current “Tops” selection), or marketplace recommendations. In other implementations, the garment layering service 112 can use other inputs and information sources to prepopulate clothing items for the clothing item selection 508. The informational element 504 also includes three empty spaces with “+” signs allowing users to select additional clothing items from the current marketplace's catalog, saved selections, or other online clothing catalogs.

In example 500-3 of FIG. 5C, the user has selected shoes as the category selection 506 for the “Build Your Look” feature to layer with the previously selected clothing item(s), which is illustrated by the UI button or outlining around the word “Shoes.” In other implementations of the user interface 502, the user's selection is indicated using other visual means. The composite image 122 provides a fitting preview of the user wearing a pair of shorts with the tee shirt selected in example 500-1.

The clothing item selections 508 currently include a pair of tennis shoes. In this scenario, the current clothing item selection 508 was chosen by the user by navigating through the marketplace catalog. In other implementations, one or more pairs of shoes are prepopulated based on recent purchasing or viewing trends of the user and/or other users, an ensemble-building recommendation service (e.g., based on the current selection of tops and bottoms), or marketplace recommendations. In other implementations, the garment layering service 112 can use other inputs and information sources to prepopulate clothing items for the clothing item selection 508. The informational element 504 also includes three empty spaces with “+” signs allowing users to select additional shoes from the current marketplace's catalog, saved selections, or other online clothing catalogs.

In the current scenario, the user has selected the tennis shoes (e.g., as indicated by the solid outline around the shirt). Upon selection of the tennis shoes, the user is presented with the layering option 510 to include or not include socks with the tennis shoes in the composite image 122. In the illustrated example 500-3, the user has opted to show the selected tennis shoes without socks for the composite image 122. The user has also selected size 10 for the selected shoes. As the user selects a particular clothing item selection 508 (e.g., the tennis shoes), the garment layering service 112 automatically updates the composite image 122 with the tennis shoes so that the user can see how the selected shirt matches the previously selected shorts. In other implementations, the user is presented with a refresh button (or similar UI element) to cause the composite image 122 to be updated based on the current selections. The user can minimize or hide the informational element 504 to get a full view of the composite image 122. In other implementations, the composite image 122 is automatically resized to fit in the user interface area above the informational element 504.

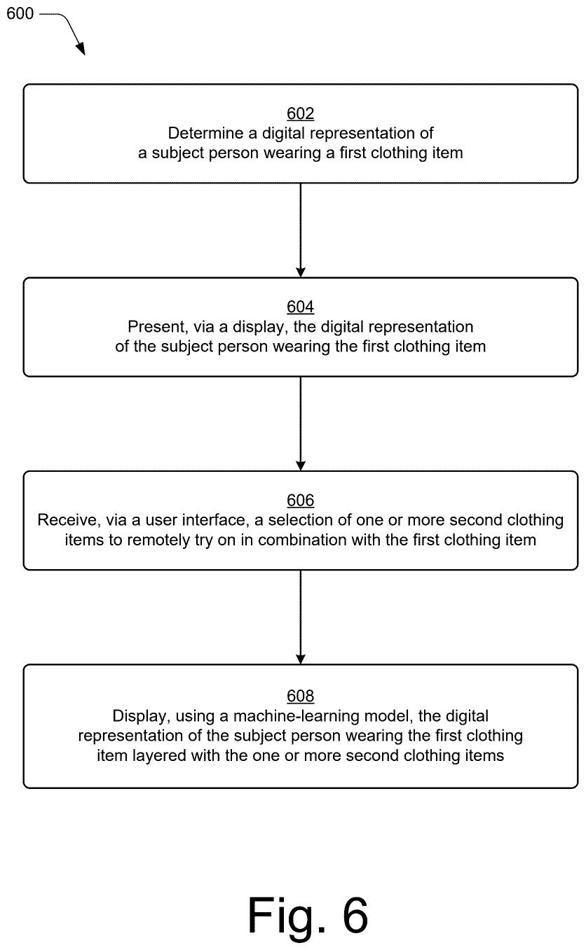

FIG. 6 is a flow diagram depicting a procedure in an example implementation of operations performable for accomplishing a result of remote apparel fitting and garment layering. To begin, a digital representation of a subject person wearing a first clothing item is determined (block 602). For example, the image compositing module 208 generates an initial composite image 214 of a digital representation of a user wearing the apparel selection 118.

In one implementation, a processing device receives a subject image 116 and the apparel selection 118, which may also indicate a selected size of the clothing item for the remote apparel fitting. A machine-learning model is then used to determine measurements of the subject person that relate or correspond to the dimensions of the selected clothing item. The machine-learning model, for example, is a parametric model (e.g., SPML model) that generates a representation of the subject person using a human mesh model with the measurements of the subject person. The clothing item's dimensions (e.g., shoulder width, waist circumference, inseam length, hip circumference, sleeve length, sleeve circumference, collar opening diameter, chest width, chest diameter) are determined or looked up by the processing device.

In at least one implementation, the machine-learning model (or another machine-learning model) then determines the fit of the clothing item on the subject person. As another example, the machine-learning model includes a generative adversarial network or a generative diffusion model that generates the reproduced image of the subject person wearing the clothing item based on the human mesh model. The image of the subject person is projected onto the human mesh model to generate the reproduced image, and the clothing item is projected onto the reproduced image of the subject person.

A digital representation of the subject person wearing the first clothing item is displayed by the processing device via a display (block 604). For example, the digital representation may include a fit representation that indicates a looseness or tightness of the first clothing item in multiple locations vis-à-vis the measurements of the subject person. The fit representation can be a heat map (e.g., grayscale or color) with a fitting key in one implementation. The processing device can also provide a textual summary of the fit or a suggestion for a better fit for a different size or clothing item. In one implementation, the reproduced image is three-dimensional or rotatable to allow views of the clothing fit from different perspectives.

A selection of one or more second clothing items is then received via a user interface (block 606). The second clothing items are to try on in combination with the first clothing item. The second clothing items, for example, are obtained or selected from a marketplace from which the first clothing item was obtained, imported in from a different marketplace, and/or imported from an image provided by the user. The selection of the second clothing items can also indicate a selected size of the second clothing items and a wearing preference for the garment layering (e.g., tucking in a shirt, cuffed pant legs, no socks with shoes, etc.).

The digital representation of the subject person wearing the first clothing item layered with the one or more second clothing items is displayed using a machine-learning model (block 608). For example, the machine-learning model that generates the layered combination of the first and second clothing items is a generative adversarial network. The user interface can allow the user to select or load one or more second clothing items for multiple garment types (e.g., bottoms, tops, shoes, outerwear, and accessories). The digital representation can be automatically updated as the user selects different clothing items within the different garment types.

### Example System and Device

FIG. 7 illustrates an example system 700, which includes an example computer 702 that represents one or more computing systems and/or devices usable to implement the techniques described herein. This is illustrated through the inclusion of the garment layering service 112. The computer 702 is configurable, for example, as a service provider server, a device associated with a client (e.g., a client device, mobile device, laptop, desktop computer, tablet, notepad), an on-chip system, and/or any other suitable computing device or computing system.

The example computer 702, as illustrated, includes a processor 704, one or more computer-readable media 706, and one or more I/O interfaces 708 that are communicatively coupled, one to another. Although not shown, the computer 702 includes a system bus or other data and command transfer system that couples the various components. For example, a system bus includes any combination of different bus structures, such as a memory bus or controller, a peripheral bus, a universal serial bus, and/or a processor or local bus that utilizes various bus architectures. Various other examples are also contemplated, such as control and data lines.

The processor 704 represents the functionality to perform one or more operations using hardware. Accordingly, processor 704 is illustrated as including hardware elements 710 that are configured as processors, functional blocks, and so forth. This includes example implementations in hardware as an application specific integrated circuit or other logic device formed using one or more semiconductors. The hardware elements 710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 706 is illustrated as including memory/storage 712. Memory/storage 712 represents memory or storage capacity associated with one or more computer-readable media. In one example, the memory/storage 712 includes volatile media (such as random access memory (RAM)) and/or nonvolatile media (such as read-only memory (ROM), Flash memory, optical disks, magnetic disks, and so forth). In another example, the memory/storage 712 includes fixed media (e.g., RAM, ROM, a fixed hard drive, and so on) and removable media (e.g., Flash memory, a removable hard drive, an optical disc, and so forth). The computer-readable media 706 is configurable in various ways, as described below.

Input/output interface(s) 708 are representative of functionality to allow a user to enter commands and information to computer 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computer 702 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

Implementations of the described modules and techniques are stored on or transmitted across some form of computer-readable media. For example, the computer-readable media includes a variety of media accessible to the computer 702. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computer 702, such as via a network. Signal media typically embodies computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 710. For example, the computer 702 is configured to implement particular instructions and/or functions corresponding to the software and/or hardware modules. Accordingly, implementation of a module executable by the computer 702 as software is achieved at least partially in hardware, e.g., through computer-readable storage media and/or hardware elements 710 of the processor 704. The instructions and/or functions are executable/operable by one or more articles of manufacture (for example, one or more computers 702 and/or processors 704) to implement techniques, modules, and examples described herein.

The techniques described herein are supportable by various configurations of the computer 702 and are not limited to the specific examples of the techniques described herein. This functionality is also implementable entirely or partially through a distributed system, such as over a “cloud” 714, as described below.

Cloud 714 includes and/or represents a platform 716 for resources 718. The platform 716 abstracts the underlying functionality of hardware (e.g., servers) and software resources of the cloud 714. For example, resources 718 include applications and/or data utilized while computer processing is executed on servers remote from the computer 702. In some examples, the resources 718 also include services provided over the Internet and/or through a subscriber network, such as a cellular or Wi-Fi network.

Platform 716 abstracts the resources 718 and functions to connect the computer 702 with other computing devices. In some examples, the platform 716 also serves to abstract scaling of resources to provide a corresponding level of scale to encountered demand for the resources implemented via the platform. Accordingly, in an interconnected device embodiment, the implementation of functionality described herein is distributable throughout system 700. For example, the functionality is partially implementable on computer 702 and via platform 716, which abstracts the functionality of cloud 714.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
determining, using a machine-learning model and based on an image of a subject person and a selection of a first clothing item, a digital representation of the subject person wearing the first clothing item;
presenting, by a processing device via a display, the digital representation of the subject person wearing the first clothing item;
receiving, via a user interface, a selection of a second clothing item to remotely try on in combination with the first clothing item; and
displaying, by the processing device via the display and using the machine-learning model, the digital representation of the subject person wearing the first clothing item layered with the second clothing item.

2. The method of claim 1, wherein the machine-learning model comprises a parametric model that generates a representation of the subject person using a human mesh model with measurements of the subject person.

3. The method of claim 2, wherein the parametric model is a skinned multi-person linear (SMPL) model.

4. The method of claim 1, wherein the machine-learning model comprises a generative adversarial network that generates the digital representation of the subject person wearing the first clothing item layered with the second clothing item.

5. The method of claim 1, wherein the second clothing item is obtained or selected from a marketplace from which the first clothing item was obtained.

6. The method of claim 1, wherein the second clothing item is imported in from a different marketplace than the first clothing item or from an image provided by a user.

7. The method of claim 1, wherein the selection of the second clothing item indicates a selected size of the second clothing item.

8. The method of claim 1, wherein the selection of the second clothing item indicates a wearing preference of a user for garment layering.

9. The method of claim 8, wherein the wearing preference includes at least one of tucking a shirt in, cuffing pant legs, or sockless.

10. The method of claim 1, wherein the user interface allows a user to select one or more garment types and a particular clothing item for each of the one or more garment types.

11. The method of claim 10, wherein the one or more garment types includes at least two of bottoms, tops, shoes, outerwear, and accessories.

12. The method of claim 10, wherein the digital representation of the subject person wearing the first clothing item layered with the second clothing item is updated as the user selects the second clothing item.

13. A computing device comprising:
a memory; and
a processing device communicatively coupled to the memory and configured to:
determine, using a machine-learning model and based on an image of a subject person and a selection of a first clothing item, a digital representation of the subject person wearing the first clothing item;
present, via a display, the digital representation of the subject person wearing the first clothing item;
receive, via a user interface, a selection of a second clothing item to remotely try on in combination with the first clothing item; and
display, via the display and using the machine-learning model, the digital representation of the subject person wearing the first clothing item layered with the second clothing item.

14. The computing device of claim 13, wherein:
the machine-learning model comprises a parametric model that generates a representation of the subject person using a human mesh model with measurements of the subject person; or
the machine-learning model comprises a generative adversarial network that generates the digital representation of the subject person wearing the first clothing item layered with the second clothing item.

15. The computing device of claim 13, wherein:
the second clothing item is obtained or selected from a marketplace from which the first clothing item was obtained; or
the second clothing item is imported in from a different marketplace than the first clothing item or from an image provided by a user.

16. The computing device of claim 13, wherein the selection of the second clothing item indicates a wearing preference of a user for garment layering, the wearing preference including at least one of tucking a shirt in, cuffing pant legs, or sockless.

17. The computing device of claim 13, wherein the user interface allows a user to select one or more garment types and a particular clothing item for each of the one or more garment types.

18. The computing device of claim 17, wherein the one or more garment types includes at least two of bottoms, tops, shoes, outerwear, and accessories.

19. The computing device of claim 17, wherein the digital representation of the subject person wearing the first clothing item layered with the second clothing item is updated as the user selects the second clothing item.

20. One or more computer-readable storage media storing instructions that, responsive to execution by a processing device, causes the processing device to:
determine, using a machine-learning model and based on an image of a subject person and a selection of a first clothing item, a digital representation of the subject person wearing the first clothing item;
present, via a display, the digital representation of the subject person wearing the first clothing item;
receive, via a user interface, a selection of a second clothing item to remotely try on in combination with the first clothing item; and
display, via the display and using the machine-learning model, the digital representation of the subject person wearing the first clothing item layered with the second clothing item.
